(19) United States
(12) Patent Application Publication
(10) Pub. No.: US 2002/0146673 A1
(43) Pub. Date: Oct. 10, 2002

(54) Breast prop/bottle prop

(76) Inventor: Laurene Marie Aranas, Yakima, WA (US)

Correspondence Address: Laurene Marie Aranas, 802 W Nob Hill, Yakima, WA, 98902, US

(21) Appl. No.: 09/824,914

(22) Filed: Apr. 4, 2001

(51) Int. Cl. G09B 23/28

(52) U.S. Cl. 434/262

(57) ABSTRACT

1. The breast prop/Bottle prop will not be used as a toy.

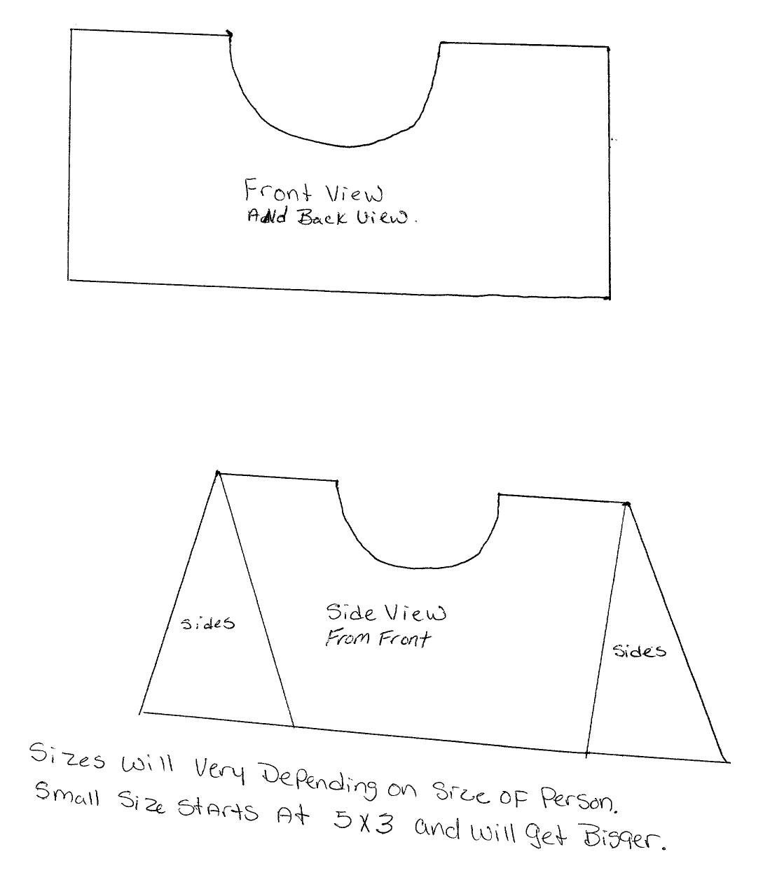

2. Do not leave baby unattended at any time

3. The art of my invention Breast prop/Bottle prop is to aid the medical field in the breast feeding course of expecting mothers. And teaching mothers how to breast feed easier and more pleasing for baby and mother.

4. Bottle prop is to aid only if mother needs to get something and baby is feeding cause you never want to take a bottle away from a feeding baby.

5. Bottle prop will rest under bottle and hold bottle up for baby, instead of useing a blanket or pillow which can cause suffication for babies.

### What Does it Do?

1. Breast Prop fits underneath the breast and puts the Breast in the lifting position.

2. The Breast Prop will put your breast in a better lifting position while you are Breast feeding your baby.

3. Will hold babies face and nose up right and away from the Breast so the baby can breath and eat easier.

4. Will aid in reattatching to the Breast if baby disconnects from the nipple.

### How Does it Work?

1. the side of the babies cheek will rest on the Breast Prop while you and your baby are laying on your sides, may also be used sitting up while you have your baby in the breast feeding position.

2. Supports breast and baby,s head for easier breathing and feeding while breast feeding.

### Advantages

1. Will help you and your new baby relax easier by reducing some difficulties of breast feeding, and will make bonding between mother and baby greater by reducing stress factors of breast feeding.

2. Will aid in helping your baby latch on to nipple properly and comfortably.

3. Will reduce the hot and sticky feeling in the summer time.

4. Will help your baby from smothering him/her self by keeping nose up and away from the breast.

5. You can lay on your side, get the rest you need by keeping your hands free, not having to worry about repositioning your breast or disturbing your baby.

6. Can use as a bottle prop also, if you need to make a phone call, go to the rest room, just lay your baby on the side and put the bottle prop under the bottle.

7. Easy to keep clean, Reusable washable baby soft covers.

### Materials

1. Foam Insert: Flame retardant polyurethane.

2. Cover: 80% Cotton/Terry and 20% Polyester.

3. Waterproofing: Poly Vinyl Chloride.

### BACKGROUND OF INVENTION

A support aid for mother and baby to ensure a more comfortable time while breast feeding.

Ther was a mother in texas who was breast feeding her baby, and fell to sleep. The baby was smothered and died of suffication from not being able to breath because the baby could not get away from mothers breast to breath. If she had the breast prop, her baby may have not sufficated and she may still have her child today.

### DETAILED DESCRIPTION OF INVENTION

1. Foam insert 5 inches thick and 7 inches long and 3 inches high with adip in the center to fit under the breast and lift up the breast. There will be larger and smaller sizes depends on size of person. There will be small, medium, large, xxx large.

2. A cotton/terry/polyester/poly vinyl chloride flame retardant polyurethane cover.

3. There will be extra covers while one is being washed.

4. Foam inserts are firm enough that the breast prop/bottle prop will not loose it,s shape.

5. Breast prop/Bottle prop are two in one,of both the same materials.

6. Bottle prop will rest under bottle and hold bottle up for baby, instead of useing a blanket or pillow which can cause suffication.

7. Bottle prop stays away from babies face so baby is free to move and eat and breath with out worrying about suffication. Bottle prop is only to be used as a temperary aid to mother.

What I claim as my invention is:

1. the Breast Prop/Bottle Prop.

2. Which aids in teaching and helping mothers and babies breast feed much more comfortably. And reduce suffication in babies.
